(19) United States
(12) Patent Application Publication
(10) Pub. No.: US 2012/0170151 A1
(43) Pub. Date: Jul. 5, 2012

(54) MAGNETIC RECORDING MEDIUM AND MAGNETIC RECORDING/REPRODUCTION APPARATUS USING THE SAME

(75) Inventors: Soichi OIKAWA, Hachioji-shi (JP); Hitoshi IWASAKI, Yokosuka-shi (JP); Masayuki TAKAGISHI, Kunitachi-shi (JP); Kenichiro YAMADA, Tokyo (JP); Tomomi FUNAYAMA, Fuchu-shi (JP); Masahiro TAKASHITA, Yokohama-shi (JP); Katsuhiko KOUI, Yokohama-shi (JP); Mariko SHIMIZU, Yokohama-shi (JP)

(73) Assignee: KABUSHIKI KAISHA TOSHIBA, Tokyo (JP)

(21) Appl. No.: 13/420,040

(22) Filed: Mar. 14, 2012

Related U.S. Application Data
(62) Division of application No. 12/421,558, filed on Apr. 9, 2009.

(30) Foreign Application Priority Data
Jun. 17, 2008 (JP) 2008-158158

(51) Int. Cl. G11B 5/127

(52) U.S. Cl. 360/110; G9B/5.04

(57) ABSTRACT

According to one embodiment, a recording track has a surface modification layer in the surface region. This surface modification layer has an anisotropic magnetic field Hk reduced from that of a region between adjacent recording tracks.

### CROSS-REFERENCE TO RELATED APPLICATIONS

This application is a division of U.S. patent application Ser. No. 12/421,558, filed Apr. 9, 2009, titled “MAGNETIC RECORDING MEDIUM AND MAGNETIC RECORDING/REPRODUCTION APPARATUS USING THE SAME,” which is hereby incorporated by reference in its entirety. Further, U.S. patent application Ser. No. 12/421,558 is based upon and claims the benefit of priority from Japanese Patent Application No. 2008-158158, filed Jun. 17, 2008, the entire contents of which are incorporated herein by reference.

### BACKGROUND

1. Field

One embodiment of the present invention relates to a perpendicular magnetic recording medium for use in, e.g., a hard disk drive using the magnetic recording technique, and a magnetic recording/reproduction apparatus.

2. Description of the Related Art

In the perpendicular magnetic recording method, the axis of easy magnetization that is conventionally pointed in the in-plane direction of a medium is made perpendicular to the medium, thereby decreasing a demagnetizing field near a magnetization transition region as the boundary between recording bits. Since the medium becomes magnetostatically stable and increases the thermal stability as the recording density increases, the method is suited to increase the areal recording density.

When a backing layer made of a soft magnetic material is formed between a substrate and perpendicular recording layer, the medium functions as a so-called perpendicular double-layered medium when combined with a single pole head, and achieves a high recording capability. The soft magnetic backing layer has a function of returning a recording magnetic field from the magnetic head. This makes it possible to increase the recording/reproduction efficiency.

To further increase the recording density of an HDD, it is effective to further decrease the magnetization reversal unit. If downsizing of magnetic crystal grains advances, however, the magnetization configuration becomes thermally unstable to cause thermal demagnetization. Although this thermal demagnetization can be suppressed by increasing the magnetic anisotropy of the recording medium, magnetization reversal hardly occurs at a high speed, and the coercive force during recording increases. To record data on a medium given a high coercive force, the write ability has been improved by increasing the saturation magnetization of a main magnetic pole of the head. However, as the write capability of the high-recording-density medium improves and the sensitivity of a read head increases as described above, magnetic mutual interference occurs between recording tracks during recording and reproduction. For example, cross-track erasure by which a signal is written in an adjacent track and cross-track read by which a signal is read out from an adjacent track take place.

To solve these problems, the magnetic head is improved by, e.g., decreasing the size of the main magnetic pole or the read track width. As the structure of the medium, a discrete track medium and the like by which the magnetic interference between data tracks is decreased by physically separating the tracks are proposed. In these media, no recording magnetic layer is formed between the data tracks or projections and recesses are formed between the tracks, thereby physically decreasing the magnetic interaction between the tracks. However, these methods may deteriorate the flying properties of the magnetic head because the projections and recesses are formed on the surface of the magnetic recording medium.

A perpendicular magnetic recording medium capable of increasing the recording track density while maintaining the flatness of the recording medium surface is disclosed in, e.g., Jpn. Pat. Appln. KOKAI Publication No. 2006-147046. This technique makes the coercive force of a data track region different from that of a region between data tracks, thereby reducing the magnetic interference between the tracks and reducing cross-track erase.

Unfortunately, demands have arisen for further increasing the recording density.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a model view exemplarily showing the structure of a magnetic recording layer used in the present invention;

FIG. 2 is a view for explaining an example of a magnetic recording medium manufacturing method according to the present invention;

FIG. 3 is a view for explaining the example of the magnetic recording medium manufacturing method according to the present invention;

FIG. 4 is a view for explaining the example of the magnetic recording medium manufacturing method according to the present invention;

FIG. 5 is a view for explaining the example of the magnetic recording medium manufacturing method according to the present invention;

FIG. 6 is a view for explaining the example of the magnetic recording medium manufacturing method according to the present invention;

FIG. 7 is a view for explaining the example of the magnetic recording medium manufacturing method according to the present invention;

FIG. 8 is a graph showing examples of the cross-track profiles of magnetic recording media;

FIG. 9 is a graph showing the dependence of Hc and Hs on the frequency when a high-frequency magnetic field is applied;

FIG. 10 is a schematic view showing an example of a magnetic recording/reproduction apparatus according to the present invention;

FIG. 11 is a view showing an example of a magnetic head assembly usable in the present invention;

FIG. 12 is a view showing an example of a magnetic recording/reproduction head usable in the present invention; and

FIG. 13 is a schematic view showing the arrangement of an example of a spin torque oscillator usable in the present invention.

### DETAILED DESCRIPTION

Various embodiments according to the invention will be described hereinafter with reference to the accompanying drawings. In general, according to one embodiment of the invention, a magnetic recording medium is a magnetic recording medium having a nonmagnetic substrate, and a magnetic recording layer formed on the nonmagnetic substrate and having concentric or spiral recording tracks. The recording track has a surface modification layer in the surface region, and an anisotropic magnetic field Hk of the surface modification layer is reduced from that of a region between adjacent recording tracks.

Also, a magnetic recording/reproduction apparatus according to the present invention comprises the magnetic recording medium described above, and a single-pole magnetic recording head.

In the present invention, an imprinting process is performed on a magnetic recording medium that is made difficult to write data on it by making the anisotropic magnetic field Hk higher than a normal value, and processing such as fluorination is performed on a recording track region by using a resist as a mask, thereby forming a large number of concentric recording tracks in which the magnetic characteristics in the upper portion of a magnetic layer are changed. A region between the recording tracks in which the processing such as fluorination has changed the magnetic characteristics maintains the state immediately after film formation, and has the Hk higher than that of the region having undergone the processing such as fluorination. In this way, two regions including the track region in which the Hk is decreased and the region formed between the tracks and having a high Hk are formed. A high Hk herein mentioned is 14 kOe or more. After the processing such as fluorination, the total Hk of the upper and lower portions of the magnetic layer in the recording track region is desirably about 14 to 10 kOe.

When data is recorded on the recording tracks by using a magnetic head, recording magnetic domains are mainly formed in only the portion having undergone the processing such as fluorination. The magnetic head cannot form any sufficient recording magnetic domains in the region between the recording tracks because the coercive force is high. That is, recording tracks having a width smaller than the track width of the magnetic head can be formed on the medium. By thus forming a very small track width, it is possible to reduce the interaction between adjacent tracks, and reduce the influence of cross-track erasure between the tracks. This makes it possible to obtain a high-density magnetic recording medium.

Also, when the present invention is used, the low-Hk surface modification layer is formed in the surface region of the recording track. When recording data, therefore, the magnetization in this low-Hk surface modification layer rotates first and starts reversing, thereby effectively promoting magnetization reversal in the lower layer coupled with the surface modification layer by exchange coupling. This decreases the total reversal magnetic field and total coercive force of the surface modification layer and lower layer. When compared to the case where no low-Hk surface modification layer is formed, this magnetization reversing mechanism can achieve a high thermal stability in the recording track region for the same reversal magnetic field.

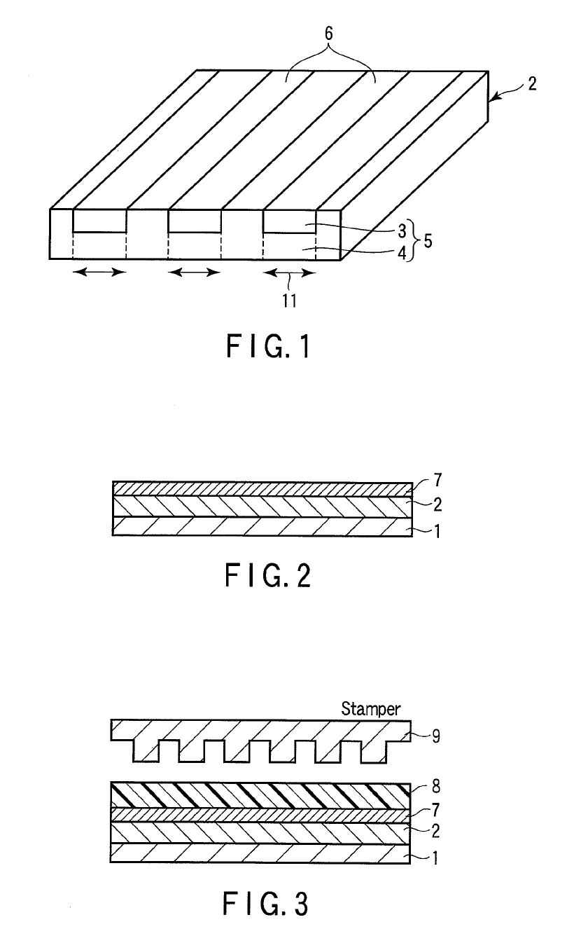

FIG. 1 is a model view exemplarily showing the structure of the magnetic recording layer used in the present invention.

As shown in FIG. 1, this magnetic recording layer has concentric or spiral recording tracks 5 having a track width 11, and side erase regions 6 formed between adjacent recording tracks 5. The recording track 5 has a surface modification layer 3 and a lower layer 4 positioned below the surface modification layer 3.

As the substrate, it is possible to use, e.g., a glass substrate, an Al-based alloy substrate, a ceramic substrate, a carbon substrate, or an Si single-crystal substrate having an oxidized surface.

Examples of the material of the glass substrate are amorphous glass and crystallized glass. As the amorphous glass, it is possible to use, e.g., versatile soda-lime glass or alumino-silicate glass. As the crystallized glass, lithium-based crystallized glass or the like can be used. As the ceramic substrate, it is possible to use, e.g., a versatile sintered product mainly containing aluminum oxide, aluminum nitride, or silicon nitride, or a fiber reinforced material of the sintered product.

As the substrate, it is also possible to use a substrate obtained by forming an NiP layer on the surface of the above-mentioned metal, a nonmetal substrate, or the like by plating or sputtering.

Although sputtering alone is explained as a method of forming a thin film on a substrate, the same effect can also be obtained by vacuum evaporation, electroplating, or the like.

The magnetic recording layer used in the present invention is, e.g., a ferromagnetic layer, and a saturation magnetization Ms can be 200 ≦Ms ≦800 emu/cc.

A CoPt-based alloy or the like can be used as the magnetic recording layer used in the present invention.

The ratio of Co to Pt in this CoPt-based alloy can be 2:1 to 9:1 in order to obtain a high uniaxial magnetocrystalline anisotropy Ku.

The CoPt-based alloy can further contain Cr.

Also, the magnetic recording layer can further contain oxygen.

Oxygen can be added in the form of an oxide. The oxide is preferably at least one compound selected from the group consisting of silicon oxide, chromium oxide, and titanium oxide.

The oxide gives the magnetic recording layer a so-called granular structure including magnetic crystal grains containing Co, and a grain boundary phase containing the amorphous oxide surrounding the grains.

The magnetic crystal grain can have a columnar structure that vertically extends through the perpendicular magnetic recording layer. The formation of this microstructure makes it possible to improve the crystal orientation and crystallinity of the magnetic crystal grains in the perpendicular magnetic recording layer. Consequently, a reproduction signal output/noise ratio (S/N ratio) suitable for high-density recording can be obtained.

The content of the oxide for obtaining the microstructure as described above can be 3 to 20 mol %, particularly, 5 to 18 mol % of the total amount of Co, Cr, and Pt. These ranges can be used as the content of the oxide in the perpendicular magnetic recording layer because when the layer is formed, an amorphous grain boundary layer in which the magnetism is weak or almost zero is formed around the magnetic crystal grains, so the magnetic crystal grains can be isolated and downsized.

If the content of the oxide in the magnetic recording layer exceeds 20 mol %, the oxide remains in the magnetic crystal grains and deteriorates the orientation and crystallinity of the magnetic crystal grains. In addition, the oxide deposits above and below the magnetic crystal grains. This often makes it impossible to form the columnar structure in which the magnetic crystal grains vertically extend through the perpendicular magnetic recording layer. If the content of the oxide is less than 3 mol %, it becomes difficult to well separate and downsize the magnetic crystal grains. Consequently, noise increases during recording and reproduction. This often makes it impossible to obtain a signal/noise ratio (S/N ratio) suited for high-density recording.

The content of Cr in the magnetic recording layer can be 0 to 30 at %, particularly, 2 to 28 at %. When the Cr content falls within these ranges, the uniaxial magnetocrystalline anisotropy constant Ku of the magnetic crystal grains is not decreased too much, and high magnetization is maintained. Consequently, recording/reproduction characteristics suitable for high-density recording and sufficient thermal decay characteristics are often obtained.

If the Cr content exceeds 28 at %, the Ku of the magnetic crystal grains decreases, and this deteriorates the thermal decay characteristics. Also, the magnetization reduces, and the reproduced signal output decreases. As a result, the recording/reproduction characteristics often worsen.

The content of Pt in the magnetic recording layer can be 10 to 25 at %. The Pt content favorably falls within this range because a Ku necessary for the perpendicular magnetic recording layer is obtained, and the crystallinity and orientation of the magnetic crystal grains improve, thereby achieving thermal decay characteristics and recording/reproduction characteristics suited to high-density recording.

If the Pt content exceeds 25 at %, a layer having the fcc structure is formed in the magnetic crystal grain, and this often deteriorates the crystallinity and orientation. If the Pt content is less than 10 at %, it is often impossible to obtain a Ku for obtaining thermal decay characteristics suitable for high-density recording.

As the magnetic recording layer, it is possible to use, instead of the above-mentioned alloy, another CoPt-based alloy, a CoCr-based alloy, a CoPtCr-based alloy, CoPtO, CoPtCrO, CoPtSi, CoPtCrSi, a multilayered structure containing Co and an alloy mainly containing at least one element selected from the group consisting of Pt, Pd, Rh, and Ru, or CoCr/PtCr, CoB/PdB, or CoO/RhO formed by adding Cr, B, or O to the multilayered structure. Since Co has the hcp structure and has uniaxial magnetocrystalline anisotropy, a high coercive force is readily obtained. Accordingly, Co can be the main component of the perpendicular magnetic recording layer.

The magnetic recording layer can have a stacked structure as needed.

When stacking layers, an interlayer made of at least one element selected from the group consisting of Cr, Fe, Co, Ni, Ru, Rh, Pd, and Pt can be formed between magnetic recording layers.

The magnetic recording layer can have a thickness of 3 to 40 nm, particularly, 5 to 30 nm singly or in the form of a stacked film. When the thickness falls within these ranges, the magnetic recording layer can operate as a magnetic recording/reproduction apparatus more suitable for high-density recording. If the thickness of the perpendicular magnetic recording layer is less than 3 nm, the crystal orientation is low, and segregation is insufficient. In addition, the reproduction output is too low, and this often makes the noise component higher than the signal. If the thickness of the perpendicular magnetic recording layer exceeds 40 nm, the reproduction output is too high, and this often distorts the waveform.

The coercive force of the perpendicular magnetic recording layer can be 237 kA/m (3 kOe) or more. If the coercive force is less than 237 kA/m (3 kOe), the thermal stability tends to decrease.

The perpendicular squareness ratio of the perpendicular magnetic recording layer can be 0.8 or more. If the perpendicular squareness ratio is less than 0.8, the thermal stability often decreases.

The effect of reducing the magnetic interference between adjacent recording tracks can be expected if the anisotropic magnetic field Hk of the surface modification layer is reduced even slightly from that of the magnetic recording layer before modification. According to an embodiment of the present invention, the anisotropic magnetic field Hk of the surface modification layer is reduced nearly 50% from that of the magnetic recording layer before modification. Consequently, the anisotropic magnetic field Hk of the recording track region including the surface modification layer and the unmodified layer below the surface modification layer is reduced nearly 20% from that of the region between adjacent recording tracks. The Hk reduction ratio of the surface modification layer can be determined by taking account of, e.g., the layer thickness or the target magnetic characteristics. If surface modification progresses too much, the magnetic characteristics of the recording track region tend to deteriorate too much. Accordingly, the layer thickness of the modification layer can be half or less the magnetic recording layer thickness. Assuming that modification progresses to the half layer thickness and the Hk is reduced 100% while the saturation magnetization Ms is maintained, the upper limit of the Hk reduction ratio of the recording track region including the upper and lower layers is presumably about 50%.

It is also possible to use, e.g., Ru as an underlying layer of the magnetic recording layer. Ru has the same hcp structure as that of Co as the main component of the recording layer. The lattice mismatch of Ru to Co is not too large, and the grain size of Ru is small. Ru is easy to obtain columnar grain growth.

Furthermore, it is possible to further decrease the grain size, improve the dispersion of the grain size, and accelerates the separation of grains by increasing the Ar gas pressure during film formation. In this case, the crystal orientation tends to worsen. However, it is possible to compensate for the deterioration of the crystal orientation by combining low-gas-pressure Ru that facilitates improving the crystal orientation as needed. The gas pressure can be low in the first half and high in the second half. The same effect as above can be expected as long as the gas pressure in the second half is relatively higher than that in the first half. The gas pressure in the second half can be 10 Pa or more. Also, the layer pressure ratio is set such that the thickness of the low-gas-pressure layer is increased when giving priority to the crystal orientation, and the thickness of the high-gas-pressure layer is increased when giving priority to, e.g., downsizing of the grains.

The grains can be further separated by adding an oxide. The oxide is particularly preferably at least one oxide selected from the group consisting of silicon oxide, chromium oxide, and titanium oxide.

The thickness of the nonmagnetic underlying layer is 2 to 50 nm, particularly, 4 to 30 nm. If the underlying layer is too thin, no sufficiently continuous film can be formed, and the crystallinity is also difficult to improve, regardless of whether the material is Ru. This makes it difficult to improve the microstructure of the magnetic recording layer formed on the underlying layer. The larger the thickness of the underlying layer, the more easily the crystallinity is improved and the coercive force of the magnetic recording layer on the underlying layer is increased. If the thickness is too large, however, the increase in spacing decreases the recording capability and recording resolution of the magnetic head.

Note that although Ru has been mainly described above, an fcc metal may also be used as the nonmagnetic underlying layer. This is so because when a (111)-oriented fcc metal is used, hcp (00.1) orientation can be given to the Co-based recording layer. This makes it possible to use, e.g., Rh, Pd, or Pt when taking account of the lattice mismatch to Co. It is also possible to use an alloy containing at least one element selected from the group consisting of Ru, Rh, Pd, and Pt, and at lest one element selected from the group consisting of Co and Cr.

In the perpendicular magnetic recording medium of the present invention, a seed layer can also be formed between the underlying layer and substrate.

The seed layer can improve the crystal grain size and crystal orientation of the magnetic recording layer through the nonmagnetic underlying layer. If the nonmagnetic underlying layer can be thinned by these improvements, it is possible to shorten the distance (spacing) between the magnetic head and soft magnetic backing layer, and improve the recording/reproduction characteristics. The seed layer can also function as a backing layer if soft magnetic characteristics can be given as the magnetism to the seed layer. This makes it possible to further shorten the distance between the magnetic head and backing layer.

The thickness of the seed layer can be 0.1 to 20 nm, particularly, 0.2 to 10 nm. If the average layer thickness is equal to or smaller than one atomic layer, the layer may be completely uniform but cannot be completely continuous. Even when the layer has an island-studded structure, however, the effect of improving the crystal grain size and crystal orientation can be expected. On the other hand, when the seed layer is made of a soft magnetic material having favorable characteristics, a maximum value is no longer limited from the viewpoint of the spacing. However, the spacing increases if there is no magnetism.

As the material of the seed layer, an hcp or fcc metal is advantageous because the crystal orientation readily improves. Even when a bcc metal is used, however, the effect of decreasing the crystal grain size of the underlying layer by the difference between the crystal structures of the seed layer and underlying layer can be expected. The seed layer is not indispensable. When forming the seed layer, however, a preferred material can contain at least one material selected from the group consisting of, e.g., Pd, Pt, Ni, Ta, Ti, and alloys of these metals. To further improve the characteristics, it is also possible to mix these materials, mix another element, or stack the materials.

A soft magnetic backing layer can also be formed between the underlying layer or seed layer and the substrate.

When a high-permeability, soft magnetic backing layer is formed in the present invention, a so-called perpendicular double-layered medium having the perpendicular magnetic recording layer on the soft magnetic backing layer is obtained. In this perpendicular double-layered medium, the soft magnetic backing layer horizontally passes a recording magnetic field from a magnetic head, e.g., a single pole head for magnetizing the perpendicular magnetic recording layer, and returns the magnetic field toward the magnetic head. That is, the soft magnetic backing layer performs a part of the function of the magnetic head. The soft magnetic backing layer can thus achieve the function of applying a sufficient steep perpendicular magnetic field to the magnetic recording layer, thereby increasing the recording/reproduction efficiency.

The soft magnetic backing layer can have a thickness of 20 to 200 nm as a single layer or as a stacked film.

As the soft magnetic backing layer, it is possible to use materials containing, e.g., Fe, Ni, and Co. Examples of the materials are FeCo-based alloys such as FeCo and FeCoV, FeNi-based alloys such as FeNi, FeNiMo, FeNiCr, and FeNiSi, FeAl-based alloys, FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN.

It is also possible to use a material having a nanocrystalline structure such as FeAlO, FeMgO, FeTaN, or FeZrN containing 60 at % or more of Fe, or a granular structure in which fine crystal grains are dispersed in a matrix.

As the material of the soft magnetic backing layer, a Co alloy containing Co and at least one of Zr, Hf, Nb, Ta, Ti, and Y can be used. The content of Co is 80 at % or more. When a film of this Co alloy is formed by sputtering, an amorphous layer is easily formed. The amorphous soft magnetic material has very good soft magnetism because the material has none of magnetocrystalline anisotropy, crystal defects, and grain boundary.

Examples of the amorphous soft magnetic material are alloys containing cobalt as a main component and zirconium as a side component, e.g., CoZr-based alloys such as CoZr, CoZrNb, and CoZrTa. B can be further added to these materials in order to facilitate the formation of the amorphous layer.

When the amorphous material is used as the soft magnetic backing layer, almost no direct influence is exerted on the crystal orientation of the metal layer formed on the soft magnetic backing layer, as when an amorphous-based substrate is used. Even when the material is changed, therefore, there is no large change in the structure or crystallinity of the magnetic recording layer, and basically the same magnetic characteristics and recording/reproduction characteristics can be expected. When only the third element is different as in the CoZr-based alloy, the differences between the saturation magnetizations (Ms), coercive forces (Hc), and permeabilities (p) are also small. Accordingly, almost equal magnetic characteristics and magnetic recording/reproduction characteristics are obtained.

The soft magnetic layer can have a structure in which soft magnetic material layers are stacked with an interlayer such as Ru interposed between them. When Ru is used as the interlayer, the layer thickness is set to about 0.8 nm. Consequently, the interlayer interaction acts between the adjacent soft magnetic layers above and below the Ru interlayer, so the magnetic moments in these soft magnetic layers can be made antiparallel to each other.

Also, an in-plane hard magnetic layer made of, e.g., a CoCrPt alloy or SmCo alloy can be formed between the substrate and soft magnetic backing layer. When this in-plane hard magnetic layer is magnetized in a desired direction, e.g., the radial direction of the disk, the axis of easy magnetization of the soft magnetic backing layer can be fixed in the direction.

Examples of a method of manufacturing the perpendicular magnetic recording medium according to the present invention will be described below.

### Example 1

A disk-like cleaned glass substrate (outside diameter=2.5 in.) was prepared as a nonmagnetic substrate. This glass substrate was placed in a film formation chamber of a magnetron sputtering apparatus (C-3010 manufactured by Canon ANELVA), and the film formation chamber was evacuated to a base pressure of 2×10⁻⁵ Pa or less. After that, magnetron sputtering was performed as follows in an Ar ambient at a gas pressure of about 0.6 Pa unless otherwise specified.

On the nonmagnetic substrate, a 30-nm thick CoZrNb alloy, 0.7-nm thick Ru, and 30-nm thick CoZrNb alloy were sequentially formed as a soft magnetic backing layer. Note that the two CoZrNb layers were antiferromagnetically coupled by Ru formed between them.

Then, a 6-nm thick Pd seed layer was formed on the CoZrNb layer.

Subsequently, a 10-nm thick Ru layer was formed, and another 10-nm thick Ru layer was stacked after the Ar gas pressure was raised to 6 Pa, thereby forming a nonmagnetic underlying layer having a total thickness of 20 nm.

Formation of First Magnetic Recording Layer

After that, a first magnetic recording layer was formed by performing sputtering in the Ar ambient at 6 Pa by using a (Co-16 at % Pt-10 at % Cr)-8 mol % SiO₂ composite target. The thickness was 20 nm.

Formation of Second Magnetic Recording Layer

Although only one magnetic recording layer can be formed as described above, a second magnetic recording layer can also be formed as needed. As the second magnetic recording layer, it is possible to stack a magnetic recording layer made of an alloy mainly containing Co, CoCr, CoPt, or CoCrPt, and a material obtained by further adding an oxide to the alloy.

Alternatively, it is possible to form a nonmagnetic interlayer about 1 nm thick made of Pd or Pt, and stack a magnetic recording layer made of an alloy mainly containing Co or CoPt and a material obtained by further adding an oxide to the alloy.

Subsequently, a 5-nm thick C protective layer was formed, and the recording medium was removed from the vacuum chamber.

Imprinting Process

FIGS. 2 to 7 illustrate the example of the magnetic recording medium manufacturing method according to the present invention.

As shown in FIG. 2, the perpendicular magnetic recording medium manufactured as described above comprises a substrate 1, a perpendicular magnetic recording layer 2 stacked on the substrate 1, and a carbon protective layer 7.

Note that for the sake of simplicity, the soft magnetic underlying layer and interlayer are not shown in FIG. 2.

As shown in FIG. 3, the protective layer 7 is spin-coated with a resist 8 about 200 nm thick. After that, a stamper 9 having a three-dimensional pattern corresponding to the three-dimensional pattern of the recording tracks 5 and servo regions 6 is pressed at 2,000 bar for 60 sec, thereby transferring the pattern to the resist 8 (high-pressure imprinting).

The press will be briefly explained below. Although not shown, the press comprises lower and upper plates of a die set. A buffer layer made of 0.1-mm thick PET, the substrate, and the stamper are stacked in this order on the lower plate of the die set, such that the resist film surface of the substrate and the three-dimensional surface of the stamper oppose each other. The upper plate of the die set is placed on the stamper, thereby sandwiching the buffer layer, substrate, and stamper between the lower and upper plates of the die set. Pressing is performed in this form. A holding time of 60 sec is equivalent to the transfer time of the resist.

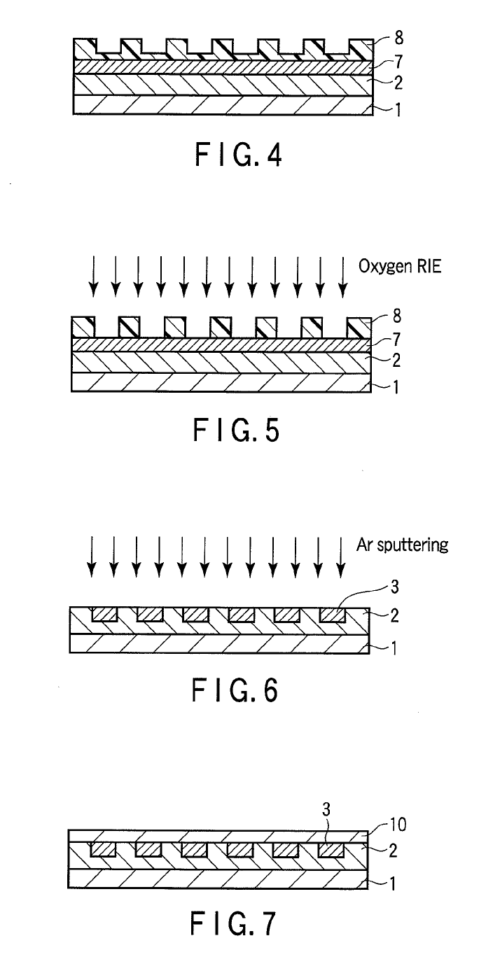

As shown in FIG. 4, the stamper 9 is removed by using vacuum forceps (not shown) after pressing. The resist does not adhere to the stamper 9 because it is coated with a fluorine-based releasing agent. Since the height of the three-dimensional pattern formed by imprinting is about 60 to 70 nm, the film thickness of the resist residue in the recessed portions of the transferred pattern is about 120 nm.

As shown in FIG. 5, the residue of the resist 8 is removed by oxygen gas RIE (Reactive Ion Etching). Although the plasma source is preferably an ICP (Inductively Coupled Plasma) by which a high-density plasma can be generated at a low pressure, it is also possible to use an ECR (Electron Cyclotron Resonance) plasma or general parallel-plate RIE apparatus. In this example, an ICP etching apparatus was used, the chamber pressure was set at 2 mTorr, and the coil RF and platen RF were set at 100 W. The resist residue formed in the recessed portions in the imprinting step was removed by performing etching for 30 sec. This etching can also remove the protective layer 7 on the surfaces of the recessed portions together with the residue.

After that, a surface modification layer 3 having adjusted magnetic characteristics can be formed by performing surface processing on the magnetic recording layer 2 in the recording track portions 5 by using the resist 8 on the projecting portions of the pattern as a mask.

In this case, the following method can also be used to reduce the Hk on the surface of the recording track region by modification.

(1) When exposed to an active gas species such as oxygen or fluorine, the magnetic material in the recessed portion causes a chemical reaction such as oxidation or fluorination, and changes the magnetic characteristics. In this case, the saturation magnetization generally decreases together with the magnetic anisotropy, and the anisotropic magnetic field and coercive force tend to decrease as well. It is also possible to ionize the active gas species, and irradiate the medium with the ions while accelerating the ions with a certain energy.

The upper portion of the magnetic layer may also be processed by etching (Ar ion milling) using an Ar ion beam.

(2) Portions corresponding to the recessed portions are etched so as to inflict damage to the magnetic layer. For example, the acceleration voltage of Ar ion milling is raised. Since this introduces defects to the magnetic layer, the magnetic anisotropy and anisotropic magnetic field decrease.

(3) Portions corresponding to the recessed portions are etched by emitting ions. The magnetic characteristics can be changed by emitting ions at energy lower than the etching energy.

Note that it is possible to maintain the flatness of the medium and obtain favorable head floating characteristics by performing the processing to such an extent that the medium surface is not roughened.

By contrast, method (1) inflicts no physical damage because the chemical reaction is used, and can maintain the smoothness of the surface without moderating the processing.

When using a halogenation reaction such as fluorination, a general resist can be used. Therefore, the resist can be easily removed by oxygen asking by which the damage to the medium surface is extremely small.

As a reaction gas containing halogen, it is possible to use, e.g., CF₄, CHF₃, CH₂F₂, C₂F₆, C₄F₈, SF₆, Cl₂, CCl₂F₂, CF₃I, or C₂F₄.

Note that the form of the active reaction gas is desirably an active radical. Radicals can be generated by various methods. For example, the existing plasma CVD apparatus or dry etching apparatus can be used. The reaction gas is supplied into a chamber of the apparatus, and a plasma is generated by applying a high-frequency voltage. As a consequence, electrons accelerated by an electric field impinge on the reaction gas to separate it, thereby generating a chemically extremely active radical. Although the substrate temperature can be room temperature, the substrate may also be heated to such an extent that there is no influence on the magnetism in the ferromagnetic material region, in order to further increase the reaction speed.

A preferred example of the plasma generator is an ICP apparatus. The ICP apparatus includes a coil RF mainly having a plasma generating function, and a platen RF having a function of guiding the plasma to the substrate side. The outputs of the coil RF and platen RF can be individually set. For example, when the coil RF is set at 300 W and the platen RF is set at 0 W, it is possible to generate a high-density plasma suited to the radical reaction, and minimize the sputtering effect because no damage is inflicted on the medium surface.

Note that to protect the medium surface against sputtering, the internal pressure of the reaction apparatus can be set at a slightly high value, e.g., 10 to 30 mTorr, particularly, about 20 mTorr. When using CF₄ as the reaction gas, the gas flow rate can be set at 10 to 50 sccm, particularly, about 20 sccm.

For example, when a magnetic material layer not covered with any resist is exposed to an active F radical generated from CF₄ gas, the exposed magnetic layer surface is often gradually fluorinated in the direction of depth by the F radical. Although the magnetization disappears if the surface is well fluorinated, the magnetic characteristics can be appropriately deteriorated by stopping the processing before that. On the other hand, a region whose surface is covered with a resist is not fluorinated and does not change the magnetic characteristics.

Note that the depth of the region where the magnetic characteristics deteriorate can be made smaller than the magnetic layer thickness, thereby giving the recording track portion a stacked structure in which two types of magnetic layers different in magnetic characteristics are stacked. Desired magnetic characteristics are readily achieved by assigning different functions to the upper and lower magnetic layers. In addition, the effect of promoting magnetization reversal in the lower layer by starting magnetization reversal in the upper layer first can be expected. Furthermore, when an interlayer is preformed to have a thickness that allows the upper and lower magnetic layers to appropriately couple with each other and the magnetic characteristics of only the portion above the interlayer are deteriorated, a so-called ECC (Exchange Coupled Composite) medium is obtained. In this case, a higher thermal stability can be obtained for the same coercive force. Although the depth depends on the target magnetic characteristics, the depth is generally preferably smaller than the half of the magnetic layer in order to keep the total coercive force of the upper and lower magnetic layers high.

The anisotropic magnetic field Hk of the medium can be decreased by 20% or more from that before the processing such as fluorination.

In a material based on hcp-CoPt, Co causes a chemical reaction more easily than Pt, and the crystallinity decreases by etching. By properly adjusting the process conditions, therefore, it is possible to manufacture a medium in which the Hk is high immediately after film formation and decreases to a value that allows recording by a magnetic head after the processing such as fluorination.

According to an embodiment of the present invention, the anisotropic magnetic field Hk of the surface modification layer can be reduced by nearly 50%. Consequently, the anisotropic magnetic field Hk of the recording track region including the surface modification layer and the unmodified layer below the surface modification layer reduces by about 20%. The Hk reduction ratio of the recording track region exceeds 50% when, e.g., the Hk reduction ratio of the surface modification layer is 100% and the layer thickness of the modification layer exceeds the half of the magnetic recording layer. In this case, the magnetic characteristics such as the coercive force often deteriorate too much. By setting the Hk reduction ratio of the recording track region at 50% or less, it is possible to hold appropriate magnetic characteristics of the recording track region, and at the same time increase the difference between the magnetic characteristics on and between the recording tracks, thereby making recording difficult in the region between the recording tracks.

Note that the deterioration degree of the magnetic characteristics and the depth were evaluated by checking the magnetic characteristics and the profile in the direction of depth of a medium having undergone the above-mentioned processing such as fluorination as non-masking processing without using any resist mask, thereby adjusting the process conditions.

As shown in FIG. 6, while the recording tracks were exposed by removing the residue, the medium was exposed to an F radical for 10 sec in an ICP apparatus by using the resist on the projecting portions of the pattern as a mask. After the magnetic characteristics in the upper portion of the recording track were deteriorated, the resist used as a mask was removed by using an oxygen asher. When a general photoresist is used, the resist can be easily removed by oxygen plasma processing. In this example, the resist was completely removed by performing processing at 1 Torr and 400 W for 5 min in an oxygen asking apparatus. The protective layer on the surface of the projecting portion was also removed together with the resist.

On the other hand, when SOG is used as an etching mask, this step must be performed by RIE using a fluorine-based gas. In this case, a chemical reaction that fluorinates the magnetic layer occurs as described previously. This makes it possible to remove SOG and deteriorate the magnetic characteristics in the upper portion of the recording track region at the same time. Although SF₆ is favorable as the fluorine-based gas, water washing must be performed because SF₆ sometimes reacts with atmospheric moisture to produce an acid such as HF or H₂SO₄.

As shown in FIG. 7, a C protective layer 10 is formed after the resist is removed. The C protective layer 10 can be formed by CVD in order to improve the coverage to the projections and recesses. However, the C protective layer 10 can also be formed by sputtering or vacuum evaporation. When CVD is used, a DLC film containing a large amount of sp³-bond carbon is formed. If the film thickness is 2 nm or less, the coverage worsens. If the film thickness is 10 nm or more, the magnetic spacing between the recording/reproduction head and medium increases, and the SNR tends to decrease. In this example, a 5-nm thick C protective layer was formed by sputtering.

In addition, a 1.5-nm thick lubricating layer made of perfluoropolyether was formed on the protective layer 10 by dipping, thereby obtaining the perpendicular magnetic recording medium of Example 1.

Note that the explanation has been made by taking the high-pressure imprinting method as an example, but the magnetic recording medium of the present invention can also be processed by using another imprinting method.

The composition of the sample surface of the magnetic recording medium thus manufactured was analyzed in the direction of depth, while the sample surface was shaved by sputtering, by using an AES (Auger Electron Spectroscopy) apparatus. As a consequence, Co was fluorinated to a depth of about 5 nm from the medium surface.

In addition, the saturation magnetization Ms and perpendicular magnetic anisotropy Ku were measured before and after the upper layer alone was fluorinated without using any resist mask, and the anisotropic magnetic field Hk was calculated by equation Hk=2 Ku/Ms. Consequently, the Hk reduced from 15 kOe to 12.5 kOe. The measured value was the total value of the upper and lower magnetic layers. According to the calculation, the Hk of the upper layer alone reduced to 8 kOe.

In this manner, the two regions, i.e., the region (surface modification layer) where the anisotropic magnetic field was reduced by fluorination and the region where no fluorination was performed and the anisotropic magnetic field remained the same were formed. The region where the anisotropic magnetic field was reduced by fluorination was used as a recording track.

Measurements of Recording/Reproduction Characteristics

The recording/reproduction characteristics were evaluated by using a read/write analyzer and spinstand.

Information was recorded and reproduced by using a perpendicular recording composite head including a shielded pole type single-pole recording element in which the distal end of an auxiliary magnetic pole was extended close to a main magnetic pole, and a giant magnetoresistance effect (GMR) reproduction element. Note that although the shielded pole type recording element was used in this example, the conventional single-pole recording element in which the auxiliary magnetic pole is spaced apart from the main magnetic pole may also be used. Also, CoFeNi was used as the material of the recording magnetic pole, but it is also possible to use a material such as CoFe, CoFeN, NbFeNi, FeTaZr, or FeTaN. An additive element may also be added to any of these magnetic materials as a main component.

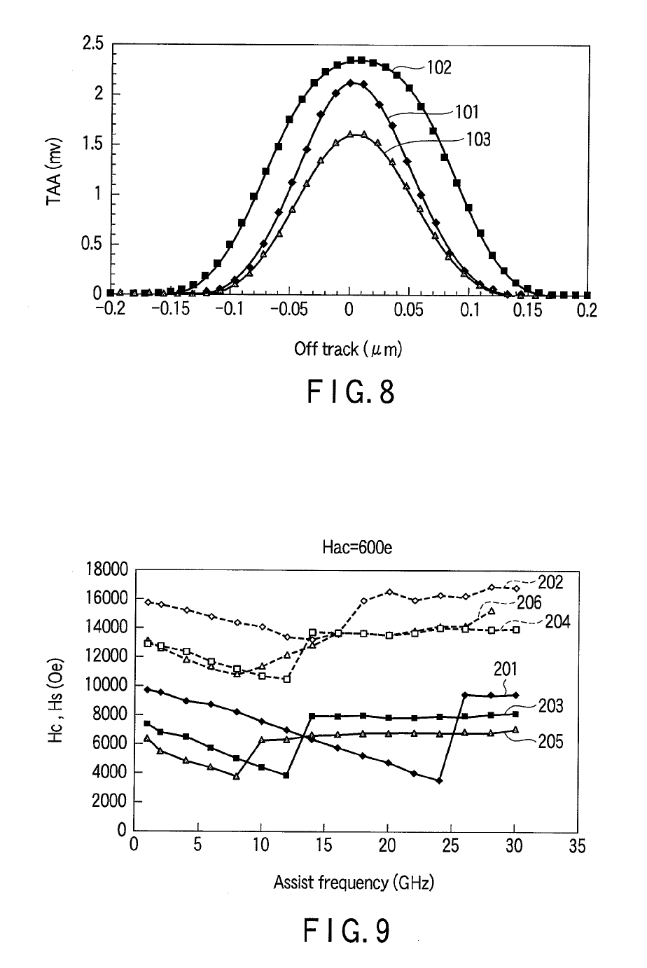

A signal having a linear recording density of 200 kfci was recorded around the region where the coercive force was decreased by fluorination, and the dependence of a reproduced output TAA on the recording current was measured. Then, a cross-track profile was measured while the radial position of the magnetic head was moved across the recorded track. FIG. 8 shows the result.

As Comparative Example 1, a magnetic recording medium having a coercive force of 4.5 kOe equivalent to that of the above-mentioned medium after fluorination was manufactured following the same procedure as in Example 1 except that no imprinting process was performed. As Comparative Example 2, a magnetic recording medium having a coercive force of 6 kOe equal to that obtained before imprinting and fluorination were performed in Example 1 was manufactured. A signal having a linear recording density of 200 kfci was recorded on each medium by using the same magnetic head, and the dependence on the recording current and the cross-track profile were measured in the same manner as in Example 1. FIG. 8 shows the results.

In FIG. 8, reference numeral 101 denotes Example 1; 102, Comparative Example 1; and 103, Comparative Example 3.

The half-width of the track profile shown in FIG. 8 is the track width that is magnetic write width. The track width is desirably small because when high-density recording is performed, a signal may be written in or read out from an adjacent track if the track width is large.

The half-widths obtained from the track profiles of Example 1 and Comparative Example 1 were respectively 110 and 160 nm, indicating that the half-width, i.e., the recording region width of Example 1 was smaller. On the other hand, although the half-width of Comparative Example 2 was also 110 nm, the TAA of Comparative Example 2 was small. This shows that the signal was not well written. That is, a write magnetic field from the magnetic head mainly formed recording magnetic domains in only the region where the coercive force was decreased by fluorination. In the region where no fluorination was performed, the coercive force of the medium was higher than the magnetomotive force of the magnetic head, so recording magnetic domains were not well formed on the medium. That is, the track width of the example was smaller than that of the comparative example even when a signal was recorded by using the same magnetic head. As described above, it was possible to reduce cross-track erasure and provide a magnetic recording medium having a higher track density by decreasing the anisotropic magnetic field in the upper portion of the recording track.

In this example, CoPtCr—SiO₂ was used as the magnetic recording layer. However, the present invention is not limited to this. The same effect can be obtained by using a CoCrPtB-based, Co/Pt-based, or Co/Pd-based multilayered film, a magnetic layer made of FePt as an ordered alloy, or another magnetic layer used in a magnetic recording layer, in which the magnetic characteristics are changed by processing such as fluorination.

Note that the medium of Example 1 was saturated by an electromagnet once, and then observed with a magnetic force microscope (MFM) by applying an opposite magnetic field around the Hn or Hc before imprinting. As a result, a region where magnetization reversal was fast and a region where magnetization reversal was slow concentrically alternately appeared at an interval corresponding to the track pitch. Thus, the way the coercive force differences were concentrically produced was readily confirmed on the magnetic recording medium according to the present invention.

A single-layered medium having Hk=14 kOe and Ms=980 emu/cc, ECC medium 1 in which interlayer coupling with a lower layer was weakened by giving Hk=7 kOe and Ms=1300 emu/cc to a 3-nm thick upper layer, and ECC medium 2 in which interlayer coupling with a lower layer was weakened by giving Hk=10 kOe and Ms=1300 emu/cc to a 3-nm thick upper layer were prepared. FIG. 9 shows the results of simulation performed on the dependence of the coercive force Hc and saturation magnetic field Hs on the frequency when a high-frequency magnetic field was applied to these media. Note that the magnetic recording medium of Comparative Example 1 was similar to the single-layered medium, and that of Example 1 was similar to ECC medium 1.

In FIG. 9, reference numeral 201 denotes the Hc of the single-layered medium; 202, the Hs of the single-layered medium; 203, the Hc of ECC medium 1; 204, the Hs of ECC medium 1; 205, the Hc of ECC medium 2; and 206, the Hs of ECC medium 2.

FIG. 9 reveals that with increasing the frequency of the assisting magnetic field, the Hc and Hs decrease to facilitate write by the DC magnetic field until a certain frequency, but the assisting effect disappears when the certain frequency is exceeded.

The dependence on the frequency as described above is obtained by a ferromagnetic resonance phenomenon, and a resonance frequency f_{ac} is given by

f_{ac}=γH_{eff}=γ(Hk_{eff}−H_{dc})/2π

where Hk_{eff} is an effective anisotropic magnetic field, and H_{dc} is an externally applied resonance magnetic field. When rewritten by H_{dc}, the above equation is represented by

H_{dc}=Hk_{eff}−2πf_{ac}/γ

The decreases in Hc and Hs with increasing the frequency as shown in FIG. 9 can be explained by the above equations. The first equation shows that when the anisotropic magnetic field is high, the resonance frequency rises, i.e., the frequency at which Hc and Hs take minimum values as shown in FIG. 9 rises.

It is possible to assume that the recording track portion has the frequency dependence of ECC medium 1 shown in FIG. 9, and the side erase portion has the frequency dependence of the single-layered medium shown in FIG. 9. When the frequency of the high-frequency assisting magnetic field is i.e., 10 GHz, therefore, the decrease ratios of the Hc and Hs of the side erase portion are lower than that of the recording track portion.

Accordingly, when magnetic recording is performed not only by using the single-pole element but also by applying a high-frequency magnetic field at the same time, it is possible to record information even if the Hc of the recording track region is further raised, and to increase the difference of writability between the recording track and the region between the recording tracks. If Hc can be raised, both Hk and Ku can also be raised, so thermal fluctuation stability can be increased. Also, the cross-track erasure can be further reduced if the difference of writability can be increased.

The aforesaid evaluation results of the recording/reproduction characteristics were presumably obtained by the mechanism as described above. Therefore, performing high-frequency magnetic field assisted recording on a medium in which the anisotropic magnetic field in the upper portion of the recording track is reduced is probably effective to further increase the thermal fluctuation stability and track density of the magnetic recording medium and magnetic recording/reproduction apparatus.

Note that the high-frequency magnetic field can be generated by superposing a high frequency on a magnetic field from the main magnetic pole, or guiding a high frequency generated outside the head to the vicinity of the main magnetic pole. However, it is perhaps most effective to install a spin torque oscillator between the main magnetic pole and auxiliary magnetic pole. The spin torque oscillator can generate a larger high-frequency magnetic field and can be incorporated into the head.

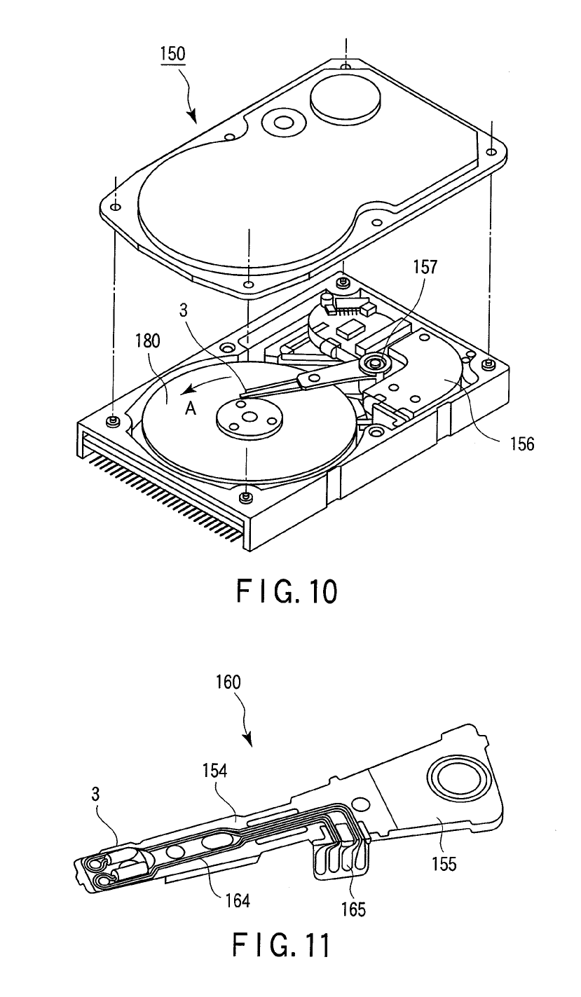

FIG. 10 is a schematic view showing an example of the magnetic recording/reproduction apparatus according to the present invention.

FIG. 11 is a view showing an example of a magnetic head assembly usable in the magnetic recording/reproduction apparatus shown in FIG. 10.

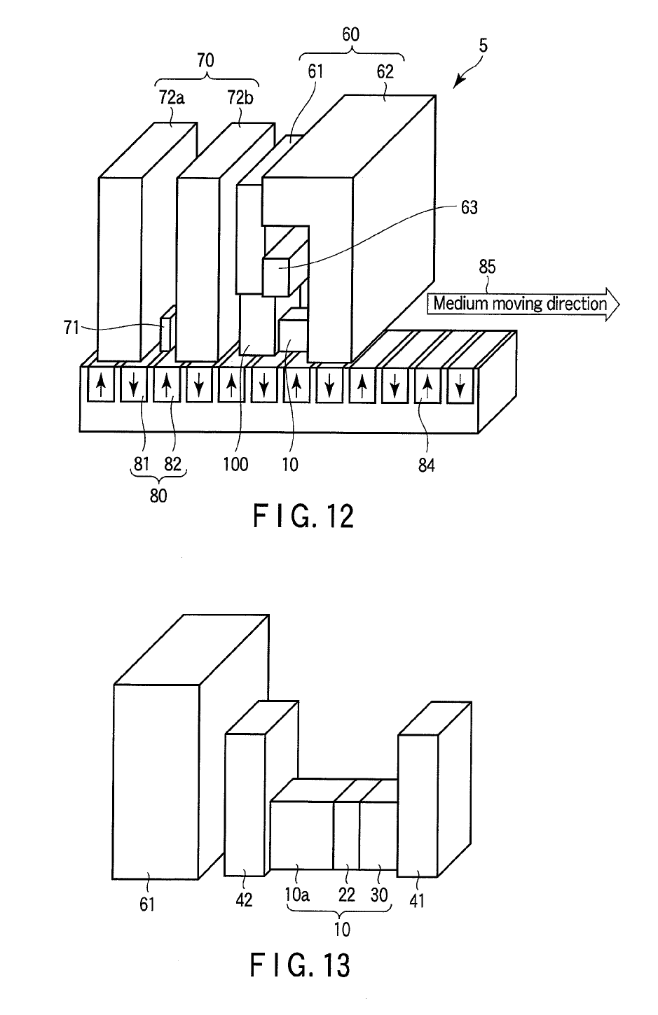

FIG. 12 is a view showing an example of a magnetic recording/reproduction head usable in the magnetic head assembly shown in FIG. 11.

A magnetic recording/reproduction apparatus 150 of the present invention is an apparatus using a rotary actuator. Referring to FIG. 10, a magnetic recording medium disk 180 is attached to a spindle 152, and rotated in the direction of an arrow A by a motor (not shown) that responds to a control signal from a driver controller (not shown). The magnetic recording/reproduction apparatus 150 of the present invention can have one or a plurality of medium disks 180.

A head slider 3 for recording information to be stored in the medium disk 180 and reproducing information therefrom is attached to the distal end of a thin-film suspension 154. The head slider 3 has, for example, a magnetic recording head 5 according to the embodiment mounted near the distal end.

When the medium disk 180 rotates, a medium opposing surface 100 (ABS) of the head slider 3 is held with a predetermined floating amount from the surface of the medium disk 180. The head slider 3 may also be a so-called “contact moving type slider” that comes in contact with the medium disk 180.

The suspension 154 is connected to one end of an actuator arm 155 having, e.g., a bobbin for holding a driving coil (not shown). A voice coil motor 156 as a kind of a linear motor is attached to the other end of the actuator arm 155. The voice coil motor 156 includes the driving coil (not shown) wound around the bobbin, and a magnetic circuit including a permanent magnet and counter yoke opposing each other so as to sandwich the coil.

The actuator arm 155 is held by ball bearings (not shown) formed in two portions above and below the spindle 157, and freely rotated and slid by the voice coil motor 156.

FIG. 11 is an enlarged perspective view showing a magnetic head assembly 160 at the distal end of the actuator arm 155 when viewed from the disk side. That is, the magnetic head assembly 160 has the actuator arm 155 having, e.g., the bobbin for holding the driving coil, and the suspension 154 is connected to one end of the actuator arm 155.

The head slider 3 including the magnetic recording/reproduction head 5 is attached to the distal end of the suspension 154. The suspension 154 has lead wires 164 for signal write and read. The lead wires 164 are electrically connected to electrodes of the magnetic head incorporated into the head slider 3. Reference numeral 165 denotes electrode pads of the magnetic head assembly 160.

The present invention can reliably record information on the perpendicular magnetic recording type medium disk 180 at a recording density higher than that of the conventional media, by using the magnetic recording/reproduction apparatus including the magnetic recording head having the element that generates a high-frequency magnetic field. Note that to perform effective high-frequency assisted recording, the resonance frequency of the medium disk 180 used is desirably made almost equal to the oscillation frequency of a spin torque oscillator 10.

As shown in FIG. 12, the magnetic recording head 5 includes a reproduction head unit 70 and write head unit 60. The reproduction head unit 70 has magnetic shield layers 72a and 72b, and a magnetic reproduction element 71 formed between the magnetic shield layers 72a and 72b.

The write head unit 60 has a main magnetic pole 61, a return bus (shield) 62, an exciting coil 63, and the spin torque oscillator 10. The individual elements of the reproduction head unit 70 and those of the write head unit 60 are spaced apart from each other by an insulator such as alumina (not shown). A GMR element or TMR (Tunnel Magneto-Resistive effect) element can be used as the magnetic reproduction element 71. To increase the reproduction resolution, the magnetic reproduction element 71 is formed between the two magnetic shield layers 72a and 72b.

FIG. 13 is a schematic view showing the arrangement of an example of the spin torque oscillator usable in the present invention.

The spin torque oscillator 10 has a structure in which a first electrode 41, a spin transfer layer 30 (second magnetic material layer), an interlayer 22 having a high spin transmittance, an oscillation layer 10a (first magnetic material layer), and a second electrode 42 are stacked in this order. A high-frequency magnetic field can be generated from the oscillation layer 10a by supplying a driving electron current 52 from the electrode 42 to the electrode 41.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording and reproduction apparatus comprising:
a magnetic recording medium comprising a nonmagnetic substrate and a magnetic recording layer on the nonmagnetic substrate, the magnetic recording layer comprising concentric or spiral recording tracks, wherein a surface modification layer in a surface region of the recording track comprises an anisotropic magnetic field weaker than an anisotropic magnetic field of a surface modification layer of a region between the recording tracks;
a single-pole magnetic recording head; and
an element near the single-pole recording head, the element configured to generate a high-frequency magnetic field.
